(19) United States
(12) Patent Application Publication
(10) Pub. No.: US 2014/0139741 A1
(43) Pub. Date: May 22, 2014

(54) ELECTRONIC DEVICE AND POWER CONTROL METHOD

(71) Applicant: KABUSHIKI KAISHA TOSHIBA, Tokyo (JP)

(72) Inventors: Kohei Momosaki, Mitaka-shi (JP); Atsushi Watanabe, Ome-shi (JP)

(73) Assignee: KABUSHIKI KAISHA TOSHIBA, Tokyo (JP)

(21) Appl. No.: 13/970,279

(22) Filed: Aug. 19, 2013

(30) Foreign Application Priority Data
Nov. 22, 2012 (JP) 2012-256114

(51) Int. Cl. H04N 5/63

(52) U.S. Cl. CPC H04N 5/63
USPC 348/553

(57) ABSTRACT

According to one embodiment, an electronic device includes a first detector, a determination controller, an activation controller, and a first instruction controller. The first detector is configured to detect a first operation from an input device. The determination controller is configured to determine whether an application for content viewing is in operation, when the first detector detects the first operation. The activation controller is configured to activate the application when the application is not in operation. The first instruction controller is configured to instruct a transition to a first power-saving state which enables restoration of the application by using a saved operation state, when the application is in operation.

### CROSS-REFERENCE TO RELATED APPLICATIONS

This application is based upon and claims the benefit of priority from Japanese Patent Application No. 2012-256114, filed Nov. 22, 2012, the entire contents of which are incorporated herein by reference.

### FIELD

Embodiments described herein relate generally to an electronic device which executes power control in accordance with an operation on a remote controller and a power control method.

### BACKGROUND

In recent years, an electronic device such as a personal computer is equipped with a function (television (TV) function) for viewing television (TV) broadcast. In the electronic device, a tuner for TV broadcast is mounted and an application (TV application) for TV viewing is installed. The TV application operates under the control of an OS (Operating System). The TV application displays TV broadcast, which is received by the TV broadcast tuner, on a display, and outputs audio from, for example, a speaker.

In addition, the electronic device equipped with the TV function, like an ordinary television apparatus, can control operations via a remote controller. The remote controller is provided with various buttons such as a channel button and a volume button for controlling the TV function, as well as a power button for powering on/off the electronic device. If a button for the TV function of the remote controller is operated while the TV function is being executed, the TV application executes control corresponding to this operated button.

In the conventional electronic device, the TV application, like other applications, operates under the control of the OS. Accordingly, when the TV function is to be operated in the electronic device which is in a power-off state, it is necessary to power on the electronic device, boot the OS, and then activate the TV application. In addition, when the TV function is to be operated once again after the operation of the TV function (TV application) is stopped, it is necessary to execute the process of activating the TV application from the beginning. Thus, even if the operation of the TV function can be controlled by using the remote controller, the TV function cannot quickly be activated with the same feeling as in the operation of an ordinary TV apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating an external-appearance structure of an electronic device of an embodiment.

FIG. 2 is an exemplary view illustrating a system configuration of a personal computer of the embodiment.

FIG. 3 is an exemplary view illustrating a relationship between modules which relate to power control corresponding to an instruction from a remote controller and control of a TV application program.

FIG. 4 is a view illustrating an example of buttons provided on the remote controller in the embodiment.

FIG. 5 is an exemplary view illustrating power control and control of the TV application program, which are executed when a TV power button and a TV application start button are operated (pressed) in each of power control states in the embodiment.

FIG. 6 is an exemplary flowchart illustrating a process by a remote-control manager program in the case of a power control state (S0) in the embodiment.

### DETAILED DESCRIPTION

Various embodiments will be described hereinafter with reference to the accompanying drawings.

In general, according to one embodiment, an electronic device comprises a first detector, a determination controller, an activation controller, and a first instruction controller. The first detector is configured to detect a first operation from an input device. The determination controller is configured to determine whether an application for content viewing is in operation, when the first detector detects the first operation. The activation controller is configured to activate the application when the determination controller detects that the application is not in operation. The first instruction controller is configured to instruct a transition to a first power-saving state configured to enable restoration of the application by using a saved operation state, when the determination controller detects that the application is in operation.

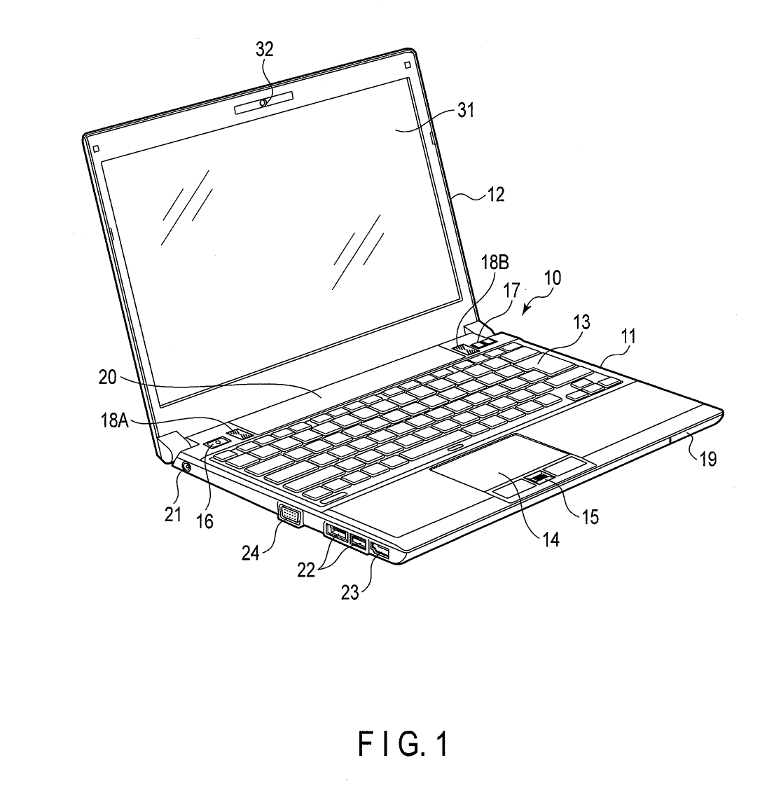

FIG. 1 is an exemplary view illustrating the external-appearance structure of an electronic apparatus according to an embodiment. The electronic apparatus is realized, for example, as a notebook-type personal computer, a tablet terminal, a desktop-type personal computer, an HDD recorder, or other various kinds of electronic devices. In the description below, the case is assumed that the electronic device is realized as a notebook-type personal computer 10.

FIG. 1 is a perspective view illustrating the computer 10, as viewed from the front side, in a state in which a display unit is opened. The personal computer 10 is configured to receive power from a battery 20. The personal computer 10 includes a computer main body 11 and a display unit 12. A display, such as a liquid crystal display (LCD) 31, is built in the display unit 12. In addition, a camera (Web camera) 32 is disposed on an upper end portion of the display unit 12.

The display unit 12 is attached to the computer main body 11 such that the display unit 12 is rotatable between an open position where the top surface of the computer main body 11 is exposed, and a closed position where the top surface of the computer main body 11 is covered with the display unit 12. The computer main body 11 has a thin box-shaped housing. A keyboard 13, a touchpad 14, a fingerprint sensor 15, a power switch 16 for powering on/off the personal computer 10, some functional buttons 17, and speakers 18A and 18B are disposed on the top surface of the computer main body 11.

In addition, a power connector 21 is provided on the computer main body 11. The power connector 21 is provided on a side surface, for example, a left side surface, of the computer main body 11. An external power supply device is detachably connected to the power connector 21. An AC adapter is usable as the external power supply device. The AC adapter is a power supply device which converts commercial power (AC power) to DC power.

The battery 20, for example, is detachably attached to a rear end portion of the computer main body 11. The battery 20 may be a battery which is built in the personal computer 10.

The personal computer 10 is driven by power from the external power supply device or power from the battery 20. If the external power supply device is connected to the power connector 21 of the personal computer 10, the personal computer 10 is driven by power from the external power supply device. The power from the external power supply device is also used in order to charge the battery 20. While the external power supply device is not connected to the power connector 21 of the personal computer 10, the personal computer 10 is driven by power from the battery 20.

In addition, the computer main body 11 is provided with some USB ports 22, an HDMI (High-Definition Multimedia Interface) output terminal 23, and an RGB port 24.

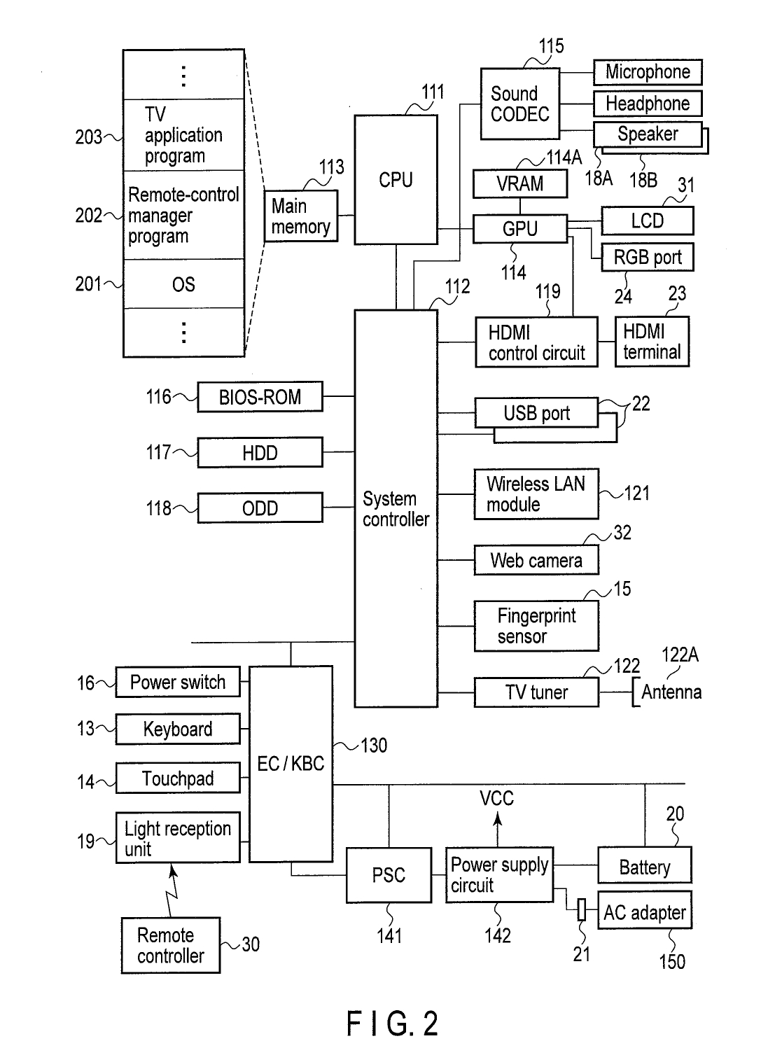

FIG. 2 illustrates the system configuration of the personal computer 10 according to the embodiment. The personal computer 10 includes a CPU 111, a system controller 112, a main memory 113, a graphics processing unit (GPU) 114, a sound CODEC 115, a BIOS-ROM 116, a hard disk drive (HDD) 117, an optical disc drive (ODD) 118, a wireless LAN module 121, a TV tuner 122, an embedded controller/keyboard controller IC (EC/KBC) 130, a power supply controller (PSC) 141, and a power supply circuit 142.

The CPU 111 is a processor which controls the operations of the respective components of the personal computer 10. The CPU 111 executes various programs which are loaded from the HDD 117 into the main memory 113. The programs include an operating system (OS) 201 and various application programs. The application programs include a remote-control manager program 202 and a TV application program 203. The remote-control manager program 202 is a program for executing a process which is associated with an instruction that is input from a remote controller 30. The TV application program 203 is a program for viewing TV broadcast (content) which is received by the TV tuner 122, and causes the display (LCD 31) to display video of a TV program and causes audio to be output from the speakers 18A and 18B via the sound CODEC 115. In addition, the TV application program 203 provides a function of displaying a program guide based on program guide data (EPG (Electronic Program Guide) data), and a function of displaying various setup screens relating to TV viewing and accepting a user operation.

Besides, the CPU 111 executes a basic input/output system (BIOS) which is stored in the BIOS-ROM 116 that is a nonvolatile memory. The BIOS is a program for hardware control. The BIOS executes control corresponding to an event which occurs due to a button operation of the remote controller 30.

The GPU 114 is a display controller which controls the LCD 31 that is used as a display monitor of the personal computer 10. The GPU 114 generates, from display data stored in a video memory (VRAM) 114A, a display signal (LVDS signal) which is to be supplied to the LCD 31. Further, the GPU 114 can also generate an analog RGB signal and an HDMI video signal from the display data. The analog RGB signal is supplied to an external display via the RGB port 24. The HDMI output terminal 23 is capable of sending an HDMI video signal (non-compressed digital video signal) and a digital audio signal to an external display over a single cable. An HDMI control circuit 119 is an interface for sending the HDMI video signal and digital audio signal to the external display via the HDMI output terminal 23.

The system controller 112 is a bridge device which connects the CPU 111 and various components. The system controller 112 includes a serial ATA controller for controlling the hard-disk drive (HDD) 117 and optical disc drive (ODD) 118.

In addition, devices, such as the USB port 22, wireless LAN module 121, Web camera 32, fingerprint sensor 15 and TV tuner 122, are connected to the system controller 112.

An antenna for receiving television (TV) broadcast is connected to the TV tuner 122 via a connector 122A. The TV tuner 122 receives TV broadcast waves via the antenna and outputs a TV broadcast signal.

The system controller 112 communicates with devices which are connected via a bus.

The EC/KBC 130 is connected to the system controller 112 via a bus. In addition, the EC/KBC 130 is mutually connected to the power supply controller (PSC) 141, power supply circuit 142 and battery 20 via a serial bus.

The EC/KBC 130 is a power management controller for executing power management of the personal computer 10, and is realized, for example, as a one-chip microcomputer including a keyboard controller for controlling the keyboard (KB) 13 and touch pad 14. The EC/KBC 130 has a function of powering on and powering off the personal computer 10 in accordance with the user's operation of the power switch 16. The power on/off control of the personal computer 10 is executed by cooperation between the EC/KBC 130 and power supply circuit controller (PSC) 141.

Upon receiving an ON signal which is sent from the EC/KBC 130, the power supply controller (PSC) 141 controls the power supply circuit 142 and powers on the personal computer 10. In addition, upon receiving an OFF signal which is sent from the EC/KBC 130, the power supply controller (PSC) 141 controls the power supply circuit 142 and powers off the personal computer 10. The EC/KBC 130, power supply controller (PSC) 141 and power supply circuit 142 operate by power from the battery 20 or AC adapter 150, even during a period in which the personal computer 10 is powered off.

The power supply circuit 142 generates power (operation power) which is to be supplied to the respective components, by using power from the battery 20, or power from the AC adapter 150 that is connected to the computer main body 11 as an external power supply.

In the meantime, the personal computer 10 of the embodiment can be set in any one of a plurality of power control states. For example, the personal computer 10 can be set in any one of power control states S0, S3, S4 and S5, S0 indicating a power-on state, S3 indicating a sleep state, S4 indicating a hibernation state, and S5 indicating a power-off state.

The sleep state (S3) is a state in which an operation state immediately before power-off of the personal computer 10 is saved in the main memory 113, and when the personal computer 10 is reactivated, a work can be resumed from the last operation state.

The hibernation state (S4) is a state in which an operation state immediately before power-off of the personal computer 10 is saved in the HDD 117, and when the personal computer 10 is reactivated, a work can be resumed from the last operation state.

The power-off state (S5) is a state in which the personal computer 10 is powered off.

For example, by the setup by the user using a power control utility, the personal computer 10 can execute setting as to which of the power control states the personal computer 10 is to be set in when the power switch 16 is operated while the personal computer 10 is in operation. Incidentally, not only when the power switch 16 is operated, but also in a case of a predetermined state, for example, when no input operation is executed for a predetermined time, the personal computer 10 can be set in the power control state which is set by the power control utility.

The time needed to transition to the power-on state (S0) is shorter in the order of the sleep state (S3), hibernation state (S4) and power-off state (S5) (S3<S4<S5). In addition, the power consumption in each power control state is greater in the order of the sleep state (S3), hibernation state (S4) and power-off state (S5) (S3>S4>S5). Besides, the time needed to transition to each power control state from the power-on state (S0) is shorter in the order of the sleep state (S3), hibernation state (S4) and power-off state (S5) (S3<S4<S5).

The sleep state (S3) and hibernation state (S4) can restore to the operation state immediately before power-off in a short time, and the power consumption in each power control state is small. Thus, the sleep state (S3) and hibernation state (S4) are called “power-saving states”.

A light reception unit 19, which receives an infrared signal that is output from the remote controller 30, is connected to the EC/KBC 130. The light reception unit 19 is always supplied with power. No matter which state of the sleep state (S3), hibernation state (S4) and power-off state (S5) the personal computer 10 is set in, the light reception unit 19 can receive a signal from the remote controller 30 and can output the signal to the EC/KBC 130.

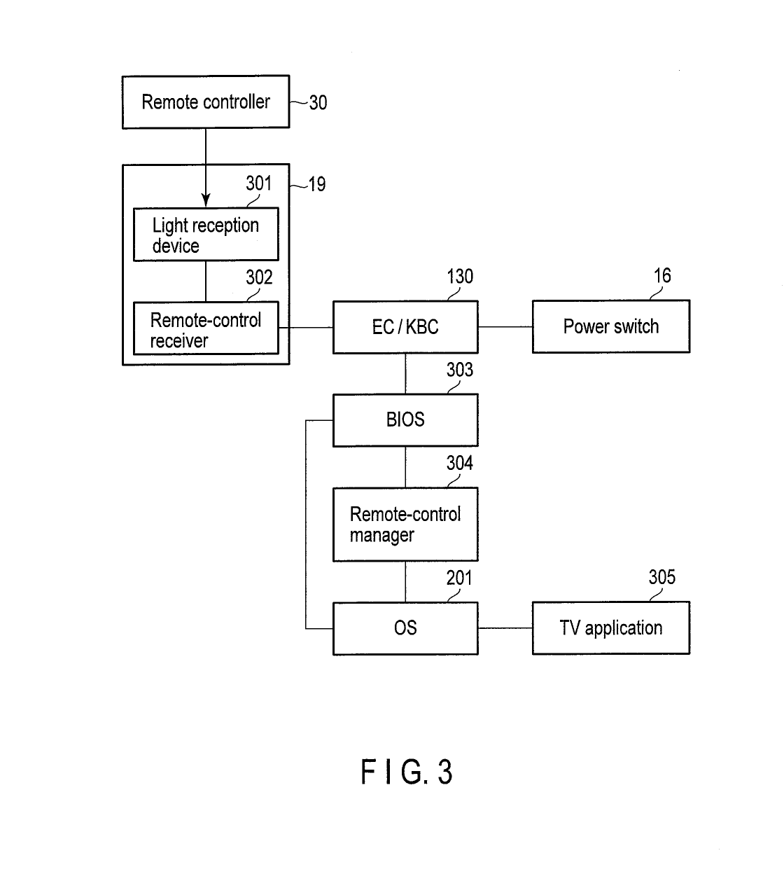

FIG. 3 is an exemplary view illustrating a relationship between modules which relate to power control corresponding to an instruction from the remote controller 30 and control of the TV application program 203 in the embodiment. In FIG. 3, a BIOS 303 is a functional module which is realized by the BIOS stored in the BIOS-ROM 116. A remote-control manager 304 is a functional module which is realized by the remote-control manager program 202. A TV application 305 is a functional module which is realized by the TV application program 203.

The remote controller 30 outputs an infrared signal indicative of a remote-control code corresponding to a button which is operated by the user. The light reception module 19 includes a light reception device 301 and a remote-control receiver 302. The remote-control receiver 302 extracts a remote-control code from a signal corresponding to the infrared signal which is received by the light reception device 301, and outputs the remote-control code to the EC/KBC 130.

The EC/KBC 130 executes power control in cooperation with the power supply controller (PSC) 141, in accordance with a signal which is input in accordance with an operation of the power switch 16 or a remote-control code relating to power control, which is received from the remote-control receiver 302. In addition, the EC/KBC 130 causes the BIOS 303 to execute a process for activation or restoration, which corresponds to the power control state.

When the remote-control code relating to the power control is received from the remote-control receiver 302, the BIOS 303 executes an activation process or a restoration process in response to an instruction corresponding to the power control state from the EC/KBC 130.

The remote-control manager 304 executes a process corresponding to the remote-control code which is received from the remote controller 30. For example, when a remote-control code for activating the TV application 305 is received from the remote controller 30 when the personal computer 10 is in the power-off state (S5) or power-saving state (S3, S4), the remote-control manager 304 activates or restores the TV application 305.

The OS 201 is booted by the BIOS 303 when power-on of the personal computer 10 is instructed. In addition, when power-off the personal computer 10 is instructed, the OS 201 executes a process for a transition to the power-saving state (S3, S4) or the power-off state (S5). The OS 201 transitions to the power-saving state (S3, S4) or the power-off state (S5) in accordance with the power control state which is set by using the power control utility or in accordance with the power control state corresponding to the remote-control code relating to the power control, which is received from the remote controller 30.

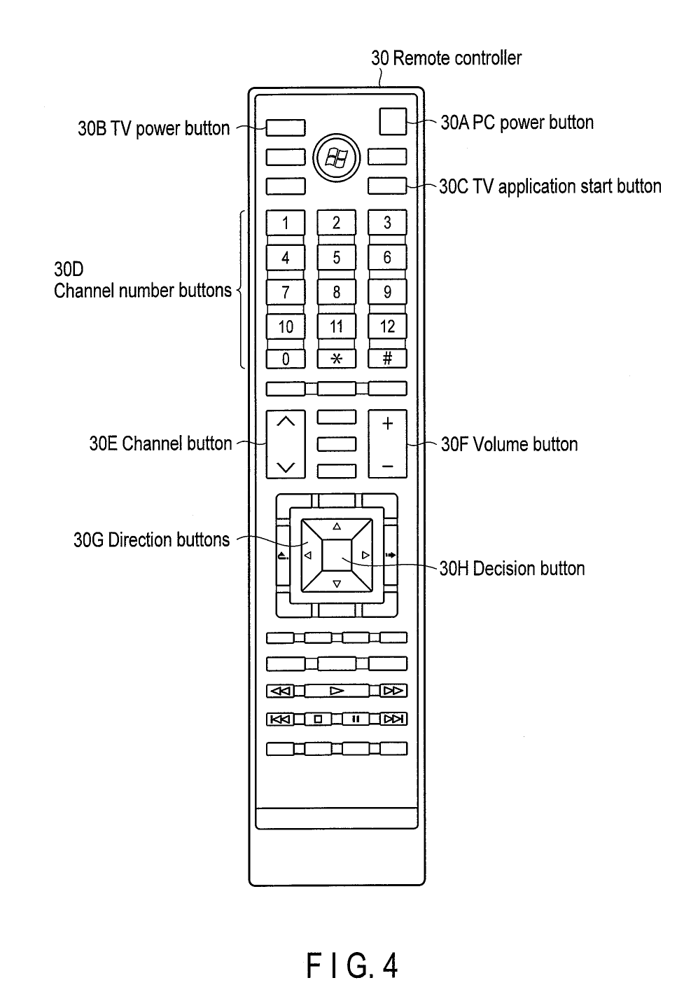

FIG. 4 is a view illustrating an example of buttons provided on the remote controller 30 in the embodiment.

The remote controller 30 is provided with, as well as a PC power button 30A for instructing power on/off of the personal computer 10, a plurality of buttons for controlling the TV function which is provided in the personal computer 10, and a button for executing a specific function (application) provided in the personal computer 10.

The buttons for controlling the TV function include, for example, a TV power button 30B, a TV application start button 30C, channel number buttons 30D, a channel button 30E, a volume button 30F, direction buttons 30G, a decision button 30H, and other various buttons.

In the remote controller 30 illustrated in FIG. 4, the buttons relating to the power control include, for example, the PC power button 30A, TV power button 30B and TV application start button 30C.

If the PC power button 30A is pressed when the personal computer 10 is in the power-saving state (S3, S4) or in the power-off state (S5), the personal computer 10 can be set in the power-on state (S0). In the case of the restoration from the power-saving state (S3, S4), restoration is made to the last state of the OS 201 or various applications, which were operated immediately before the power-off. In the case of the activation from the power-off state (S5), the 201 is booted and then a predetermined application, for instance, is activated.

If the PC power button 30A is pressed when the personal computer 10 is in the power-on state (S0), the personal computer 10 can be set in the power-saving state (S3, S4) or in the power-off state (S5). For example, based on the setup content by the power control utility, it is determined which of the sleep state (S3), hibernation state (S4) and power-off state (S5) the personal computer 10 is to be set in when the PC power button 30A is pressed.

The TV power button 30B is a button for instructing ON/OFF of the TV function, and the TV application start button 30C is a button for instructing start/stop of the TV application 305.

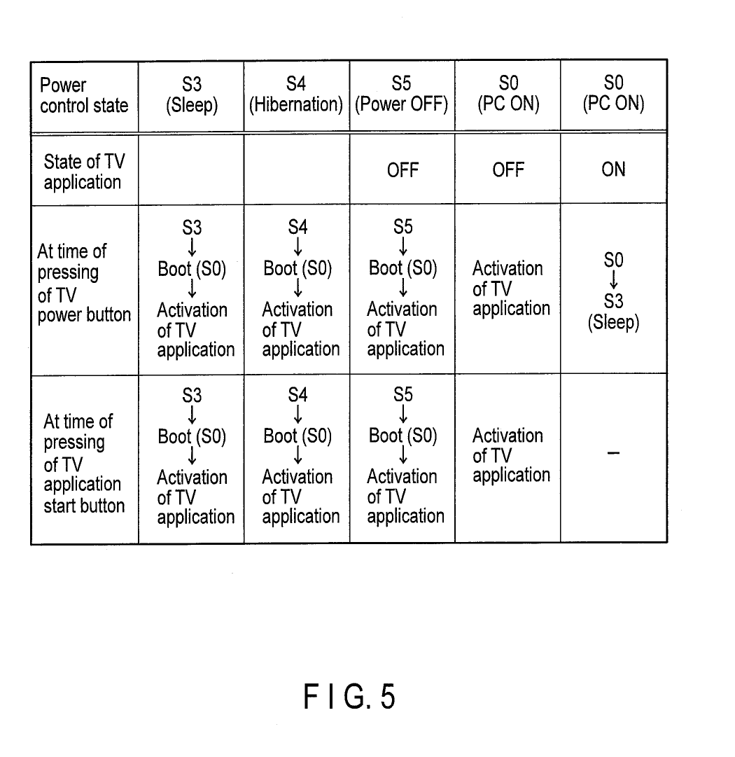

FIG. 5 is an exemplary view illustrating power control and control of the TV application program 203, which are executed when the TV power button 30B and TV application start button 30C are operated (pressed) in each of the power control states in the embodiment.

To begin with, a description is given of the case in which the TV application start button 30C is pressed.

(A1) If the TV application start button 30C is pressed when the personal computer 10 is in the power-off state (S5), the EC/KBC 130 receives a remote-control code indicative of pressing of the TV application start button 30C from the light reception unit 19 (remote-control receiver 302), and causes the BIOS 303 to execute an activation process.

Responding to an event indicated by the remote-control code, the BIOS 303 stores data indicative of the activation of the TV application, for example, in the BIOS-ROM 116, and executes an activation process (wakeup) for a transition from the power-off state (S5) to the power-on state (S0). Thereby, the OS 201 and the TV application program 203 are activated.

At the time of the activation, the remote-control manager 304 refers to the BIOS-ROM 116, and determines whether the data indicative of the activation of the TV application is stored or not. If the data indicative of the activation of the TV application is stored, the remote-control manager 304 starts the TV application program 203.

(A2) If the TV application start button 30C is pressed when the personal computer 10 is in the power-saving state (S3, S4), the EC/KBC 130 receives a remote-control code indicative of pressing of the TV application start button 30C from the light reception unit 19 (remote-control receiver 302), and causes the BIOS 303 to execute an activation process.

Responding to an event indicated by the remote-control code, the BIOS 303 stores data indicative of the activation of the TV application, for example, in the BIOS-ROM 116, and executes a restoration process (wakeup) for a transition from the power-saving state (S3, S4) to the power-on state (S0). Thereby, the OS 201 and the TV application program 203 are restored to the operation state immediately before the power-off.

At the time of the restoration from the power-saving state, the remote-control manager 304 refers to the BIOS-ROM 116, and determines whether the data indicative of the activation of the TV application is stored or not. If the data indicative of the activation of the TV application is stored and the TV application program 203 has not yet been activated, the remote-control manager 304 activates the TV application program 203.

(A3) When the personal computer 10 is in the power-on state (S0) and the TV application program 203 is not operated, the remote-control manager 304 starts the TV application program 203 in accordance with a remote-control code indicative of pressing of the TV application start button 30C.

Next, a description is given of the case in which the TV power button 30B is pressed.

(B1) If the TV power button 30B is pressed when the personal computer 10 is in the power-off state (S5), the EC/KBC 130 receives a remote-control code indicative of pressing of the TV power button 30B from the light reception unit 19 (remote-control receiver 302), and causes the BIOS 303 to execute an activation process.

Responding to an event indicated by the remote-control code, the BIOS 303 stores data indicative of the activation of the TV application, for example, in the BIOS-ROM 116, and executes an activation process (wakeup) for a transition from the power-off state (S5) to the power-on state (S0). Thereby, the OS 201 and the TV application program 203 are activated.

At the time of the activation, the remote-control manager 304 refers to the BIOS-ROM 116, and determines whether the data indicative of the activation of the TV application is stored or not. If the data indicative of the activation of the TV application is stored, the remote-control manager 304 starts the TV application program 203.

(B2) If the TV power button 30B is pressed when the personal computer 10 is in the power-saving state (S3, S4), the EC/KBC 130 receives a remote-control code indicative of pressing of the TV power button 30B from the light reception unit 19 (remote-control receiver 302), and causes the BIOS 303 to execute an activation process.

Responding to an event indicated by the remote-control code, the BIOS 303 stores data indicative of the activation of the TV application, for example, in the BIOS-ROM 116, and executes a restoration process for a transition from the power-saving state (S3, S4) to the power-on state (S0). Thereby, the OS 201 and the TV application program 203 are restored to the operation state immediately before the power-off. The time needed for the transition from the power-saving state (S3, S4) to the power-on state (S0) is shorter than the time needed for the start from the power-off state (S5).

At the time of the restoration from the power-saving state, the remote-control manager 304 refers to the BIOS-ROM 116, and determines whether the data indicative of the activation of the TV application is stored or not. If the data indicative of the start of the TV application is stored and the TV application program 203 has not yet been activated, the remote-control manager 304 starts the TV application program 203.

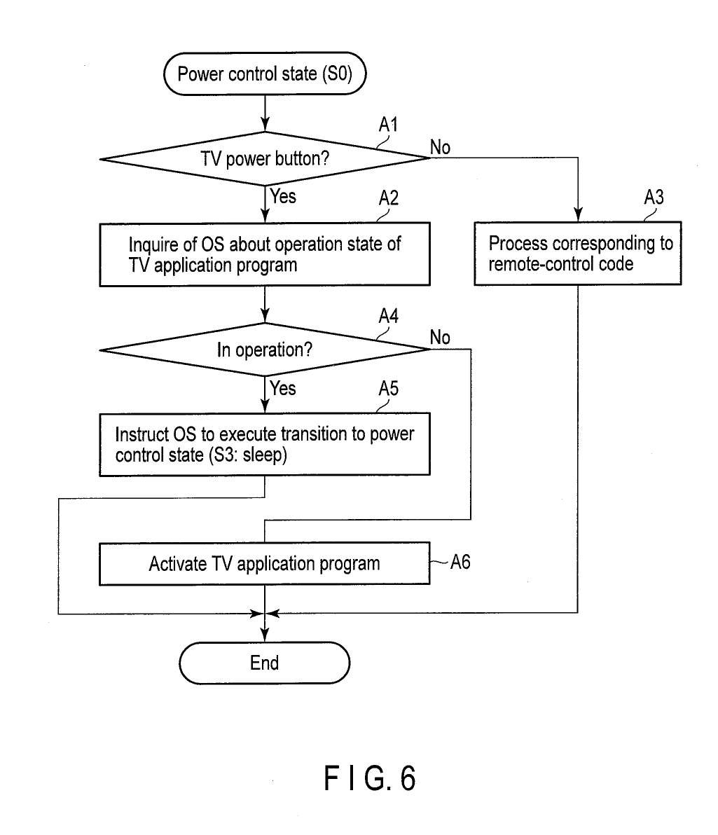

FIG. 6 is an exemplary flowchart illustrating a process by the remote-control manager program 202 in the case of the power control state (S0) in the embodiment.

When the personal computer 10 is in the power control state (S0), if a remote-control code, other than the remote-control code indicative of pressing of the TV power button 30B, is received (No in block A1), the remote-control manager 304 causes the TV application 305 to execute a process corresponding to the remote-control code (the button pressed by the user) (block A3).

On the other hand, when the personal computer 10 is in the power-on state (S0), if the TV power button 30B of the remote controller 30 is pressed (Yes in block A1), the remote-control manager 304 inquires of the OS 201 about the operation state of the TV application program 203 (TV application 305), responding to the remote-control code indicative of pressing of the TV power button 30B (block A2).

In the embodiment, it is determined that the TV application program 203 is in operation, when the TV application program 203 is in any one of the states described below. For example, the TV application program 203 is determined to be in operation, when a display area (window), which is displayed on the screen by the TV application 305, is being designated by a pointing device or the like, when the window, which displays video of TV broadcast by the TV application 305, is an active window, when the window, which displays video of TV broadcast, is in a full-screen display mode, or when there is a process which is executed by the TV application 305.

When the remote-control manager 304 has determined, by the inquiry from the OS 201, that the TV application 305 is not in operation (No in block A4), the remote-control manager 304 starts the TV application program 203 (TV application 305) (block A6).

On the other hand, when the TV power button 30B has been pressed, if the remote-control manager 304 receives a response indicating that the TV application 305 is in one of the above-described states, the remote-control manager 304 determines that the TV application 305 is in operation (Yes in block A4). In this case, the remote-control manager 304 instructs the OS 201 to execute a transition to the sleep state (S3) (block A5). Responding to the request from the remote-control manager 304, the OS 201 causes the personal computer 10 to transition to the sleep state (S3).

Specifically, when the user presses the TV power button 30B of the remote controller 30 while the TV application 305 is in operation, this indicates the user's intention to end viewing of TV broadcast. The personal computer 10 terminates viewing of TV broadcast by transitioning to the sleep state (S3) in accordance with an instruction by the operation of the TV power button 30B.

In addition, by the transition to the sleep state (S3), when the TV power button 30B is pressed once again, quick restoration can be made to the operation state immediately before the transition to the sleep state (S3), as described above.

Usually, the time needed for the transition from the power-on state (S0) to the sleep state (S3) is shorter than the time needed for the transition from the power-on state (S0) to the power-off state (S5). In addition, as described above, the time needed for the restoration from the sleep state (S3) in response to the pressing of the TV power button 30B is short. Thus, by the operation (pressing) of the TV power button 30B alone, quick start/stop of the TV application 305 can be realized.

When only viewing of TV broadcast is to be stopped and another application is to be executed by the personal computer 10, it should suffice if the user presses the TV application start button 30C of the remote controller 30. In this case, the remote-control manager 304 terminates the operation of the TV application 305. The personal computer 10 is kept in the power-on state (S0).

In addition, in the above description, if the TV power button 30B is pressed while the TV application 305 is in operation, the personal computer 10 is made to transition to the sleep state (S3). Alternatively, in this case, the personal computer 10 may be set in the hibernation state (S4) from which restoration can be made in a shorter time than from the power-off state (S5). Whether the personal computer 10 is to be set in the sleep state (S3) or in the hibernation state (S4) in response to pressing of the TV power button 30B may be preset by a user operation. For example, mode data, which indicates to which of the power-saving states a transition is to be made in response to an instruction from the user, is stored in a nonvolatile storage medium such as the BIOS-ROM 116, and when the TV power button 30B has been pressed, the remote-control manager 304 refers to the mode data and instructs the OS 201 as to which power-saving state a transition should occur to.

In the above description, regardless of the power control state which is set by the power control utility, a transition occurs to the sleep state (S3) in response to the pressing of the TV power button 30B. For example, even if the power control utility has made such setting that a transition is to occur to the power-off state (S5) when power-off is instructed by an operation of the PC power button 30A, a transition occurs to the sleep state (S3) in response to pressing of the TV power button 30B.

Meanwhile, when the transition to the sleep state (S3) or hibernation state (S4) is set by the power control utility, a transition may be made to the power-saving state which is set by the power control utility, in response to pressing of the PC power button 30A.

In the above description, when the TV power button 30B has been pressed while the TV application 305 is in operation, a transition is made to the sleep state (S3). Thus, if the TV power button 30B is pressed once again after the transition to the sleep state (S3), restoration is made to the state immediately before the transition to the sleep state (S3). Accordingly, for example, if the TV power button 30B is pressed while a program guide is being displayed on the screen by the TV application 305, the screen displaying the program guide is first displayed at the time of the restoration.

Meanwhile, when the TV application 305 is to be restored in response to pressing of the TV power button 30B, activation may be executed in a predetermined operation state. For example, such setting is possible that a screen which displays TV broadcast is always displayed as an initial screen at a time of restoration by the pressing of the TV power button 30B.

In this case, when the TV power button 30B has been pressed while the TV application 305 is in operation, the remote-control manager 304 causes the TV application 305 to transition to a predetermined operation state (e.g. a display state of the screen on which TV broadcast is displayed), and then instructs the OS 201 to transition to the sleep state (S3) (or hibernation state (S4)). Thereby, at the time of restoration by the pressing of the TV power button 30B, restoration can be made in the predetermined operation state.

Alternatively, when the TV power button 30B has been pressed while the TV application 305 is in operation, a transition may immediately be made to the sleep state (S3) (or hibernation state (S4)), and at a time of restoration, the remote-control manager 304 may instruct the TV application 305 to transition to a predetermined operation state.

Furthermore, when activation has been instructed by the pressing of the PC power button 30A, restoration may be made to the state immediately before the transition to the sleep state (S3), and when activation has been instructed by the pressing of the TV power button 30B, the TV application 305 may be restored to a predetermined operation state.

The above description has been given of the example in which the TV application is operated by the remote controller 30. However, some other application may be set to be the target of the operation. For example, an application for viewing contents other than TV broadcast may be set to be the target of the operation. Contents other than TV broadcast are, for example, various kinds of contents (including moving pictures, still images, music, etc.) which are recorded in advance in the personal computer 10, and contents which are received via a network (wires, wireless).

Besides, when the TV power button 30B, which is provided on the remote controller 30, is pressed, a transition occurs to the S3 (sleep) state if the TV application is in operation. Alternatively, when a predetermined button provided on the main body of the computer 10 is pressed, the same process as in the above-described case in which the TV power button 30B is pressed may be executed.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

What is claimed is:

1. An electronic device comprising:
a first detector configured to detect a first operation from an input device;
a determination controller configured to determine whether an application for content viewing is in operation, when the first detector detects the first operation;
an activation controller configured to activate the application when the determination controller detects that the application is not in operation; and
a first instruction controller configured to instruct a transition to a first power-saving state configured to enable restoration of the application by using a saved operation state, when the determination controller detects that the application is in operation.

2. The electronic device of claim 1, further comprising a second instruction controller configured to instruct restoration of the application, when the first detector detects the first operation in the first power-saving state.

3. The electronic device of claim 1, further comprising:
a second detector configured to detect a second operation in the input device; and
a second instruction controller configured to instruct a transition to a second power-saving state when the second detector detects the second operation.

4. The electronic device of claim 1, further comprising a receiver configured to receive a signal from the input device,
wherein the first detector is configured to detect the first operation, based on a code indicated by the signal.

5. The electronic device of claim 1, further comprising a transition controller configured to cause the application to restore to a first operation state from the first power-saving state.

6. A power control method comprising:
detecting an operation on a first input device;
determining whether an application for content viewing is in operation, when the operation is detected;
activating the application when the application is not in operation; and
instructing a transition to a power-saving state configured to enable restoration of the application by using the saved operation state, when the application is in operation.

7. A computer-readable, non-transitory storage medium comprising a computer program configured to be executed by a computer, the computer program controlling the computer to execute functions of:
detecting an operation on a first input device;
determining whether an application for content viewing is in operation, when the operation is detected;
activating the application when the application is not in operation; and
instructing a transition to a power-saving state configured to enable restoration of the application by using the saved operation state, when the applications is in operation.
